(19) United States
(12) Patent Application Publication
(10) Pub. No.: US 2026/0155437 A1
(43) Pub. Date: Jun. 4, 2026

(54) ALL-SOLID-STATE BATTERY AND METHOD OF MANUFACTURING THE SAME

(71) Applicant: Samsung Electro-Mechanics Co., Ltd., Suwon-si (KR)

(72) Inventors: Taeyoung KIM, Suwon-si (KR); Jeongkuk SHON, Suwon-si (KR); Heungchan LEE, Suwon-si (KR)

(21) Appl. No.: 19/405,995

(22) Filed: Dec. 2, 2025

(30) Foreign Application Priority Data
Dec. 3, 2024 (KR) 10-2024-0177900
Sep. 30, 2025 (KR) 10-2025-0143043
Dec. 1, 2025 (KR) 10-2025-186657

(51) Int. Cl. H01M 10/0562; H01M 10/0585; H01M 50/117; H01M 50/128

(52) U.S. Cl. CPC H01M 10/0562; H01M 10/0585; H01M 50/117; H01M 50/128; H01M 2300/0077

(57) ABSTRACT

An all-solid-state battery and a method of manufacturing the same. The all-solid-state battery includes a multilayer structure, a first cover layer and a second cover layer opposite the first cover layer. The multilayer structure includes a solid electrolyte layer including a solid electrolyte, a cathode layer provided on a first side of the solid electrolyte layer, a portion of which extends to a first edge of the solid electrolyte layer, a first margin layer provided on an area of the first side of the solid electrolyte layer, an anode layer provided on a second side of the solid electrolyte layer, and a second margin layer provided on an area of the second side of the solid electrolyte layer. Moreover, at least one of the first cover layer, the second cover layer, the first margin layer, or the second margin layer includes an oxide including a pyrochlore crystalline material.

### CROSS-REFERENCE TO RELATED APPLICATION

This application claims priority to Korean Patent Application Nos. 10-2025-186657, filed on Dec. 1, 2025, 10-2025-0143043, filed on Sep. 30, 2025, and 10-2024-0177900, filed on Dec. 3, 2024 in the Korean Intellectual Property Office, and all the benefits accruing therefrom under 35 U.S.C. § 119, the disclosures of which in their entirety are incorporated by reference herein.

### BACKGROUND

### 1. Field

The disclosure relates to an all-solid-state battery and a method of manufacturing the all-solid-state battery.

### 2. Description of the Related Art

Many existing lithium batteries use liquid electrolytes, many of which include flammable organic solvents. Accordingly, there is a possibility of overheating, and possibly resulting fires in the event of a short circuit, with such batteries. To address such operational safety concerns, all-solid-state batteries using solid electrolytes rather than liquid electrolytes are of interest.

Among solid electrolytes for all-solid-state batteries, a garnet-type oxide solid electrolyte is one material with high ionic conductivity and is known as a key material for oxide all-solid-state batteries due to excellent chemical stability with lithium.

In order to improve energy density in all-solid-state batteries including solid electrolytes, battery units are multilayered. During multilayering, a cover layer is provided at each of an upper side and a lower side in a stacking direction of an all-solid-state battery, or a margin layer is required to protect internal cells.

### SUMMARY

Provided is an all-solid-state battery that may effectively protect internal cells from the outside and improve energy density and rate characteristics.

Provided is a method of manufacturing the all-solid-state battery.

Additional aspects will be set forth in part in the description which follows and, in part, will be apparent from the description, or may be learned by practice of the presented embodiments of the disclosure.

According to an aspect of the disclosure, an all-solid-state battery includes a multilayer structure including a first cover layer as a first outermost layer of the multilayer structure in a stacking direction, and a second cover layer disposed at a side opposite the first cover layer and stacked as a second outermost layer of the multilayer structure. The multilayer structure includes: a solid electrolyte layer including a solid electrolyte; a cathode layer provided on a first side of the solid electrolyte layer, wherein a portion of the cathode layer extends to a first edge of the solid electrolyte layer; a first margin layer provided on an area of the first side of the solid electrolyte layer including an area proximate to a second edge of the solid electrolyte opposite the first edge in which the cathode layer is not provided (or absent). The multilayer structure also includes an anode layer provided on an opposite second side of the solid electrolyte layer, wherein a portion of the anode layer extends to the second edge of the solid electrolyte layer; and a second margin layer is provided on an area of the second side of the solid electrolyte layer including an area proximate to the first edge of the solid electrolyte in which the anode layer is not provided (or absent). Moreover, at least one of the first cover layer, the second cover layer, the first margin layer, or the second margin layer includes an oxide including a pyrochlore crystalline material.

The pyrochlore crystalline material may be a compound represented by Formula 1:

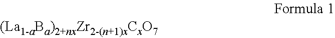

wherein, in Formula 1,
B is one or more trivalent cations,
C is one or more tetravalent cations, one or more pentavalent cations, or one or more hexavalent cations,

$$0 \leq a < 1 , 0 \leq x < 0.66 , and$$

$$n = ( oxidation number of C ) - ( oxidation number of Zr ) .$$

In Formula 1, B may includes scandium (Sc), yttrium (Y), aluminum (Al), gallium (Ga), or indium (In), and C may include tungsten (W), niobium (Nb), bismuth (Bi), antimony (Sb), or tantalum (Ta).

The pyrochlore crystalline material represented by Formula 1 may be a compound represented by Formula 2.

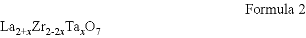

wherein, in Formula 2, 0≤x<0.66.

Peaks in an X-ray diffraction (XRD) spectrum of the oxide may appear at diffraction angles (2θ) of about 27.5° to about 29°, about 32° to about 33.5°, about 46.5° to about 48°, and about 55° to about 56.5°.

The oxide may further include an amorphous material.

A content of the pyrochlore crystalline material in the oxide may be in a range of about 50 parts by weight to about 99.9 parts by weight with respect to 100 parts by weight of a total weight of the oxide.

A weight ratio G_{La}/G_{Li} of lanthanum to lithium in at least one of the first cover layer, the second cover layer, the first margin layer, and the second margin layer may be in a range of about 3 to about 5.

The oxide may have lower ionic conductivity than the solid electrolyte. The oxide may have an ionic conductivity of 1.0×10⁻⁸ Siemens per centimeter (S/cm) or less.

At least one of the first cover layer, the second cover layer, the first margin layer, and the second margin layer may have an electrical conductivity of less than 1.0×10⁻⁷ S/cm.

The all-solid-state battery may further include a third margin layer disposed on an extended plane of the solid electrolyte layer and having a structure that partially overlaps the first margin layer and the second margin layer.

A weight ratio G_{La}/G_{Li} of lanthanum to lithium of at least one of the first cover layer, the second cover layer, the first margin layer, and the second margin layer may be smaller than that of the solid electrolyte layer.

According to an aspect of the disclosure, a method of manufacturing an all-solid-state battery includes:
preparing a cathode structure having a first margin layer-forming composition that does not overlap a cathode layer;
preparing an anode structure formed having a second margin layer-forming composition that does not overlap an anode layer;
forming a multilayer structure having a solid electrolyte-forming composition disposed between the cathode structure and the anode structure;
providing a first cover layer-forming composition on a first outermost layer of the multilayer structure;
providing a second cover layer-forming composition on a second outermost layer of the multilayer structure, the second outermost layer disposed opposite the first outermost layer of the multilayer structure, to provide a stack; and
heat-treating the stack,
wherein the all-solid-state battery includes the multilayer structure, a first cover layer as the first outermost layer of the multilayer structure in a stacking direction, and a second cover layer disposed opposite the first outermost layer and stacked as the second outermost layer,
wherein the multilayer structure includes: a solid electrolyte layer including a solid electrolyte; a cathode layer provided on a first side of the solid electrolyte layer, wherein a portion of the cathode layer extends to a first edge of the solid electrolyte layer; a first margin layer provided on an area of the first side of the solid electrolyte layer including an area proximate to a second edge of the solid electrolyte in which the cathode layer is not provided (or absent); and an anode layer provided on a second side of the solid electrolyte layer, wherein a portion of the anode layer extends to the second edge of the solid electrolyte layer, and a second margin layer provided on an area of the second side of the solid electrolyte layer including an area proximate to the first edge of the solid electrolyte in which the anode layer is not provided (or absent). Moreover, at least one of the first cover layer, the second cover layer, the first margin layer, or the second margin layer includes an oxide including a pyrochlore crystalline material.

The heat-treating may be performed at a temperature of about 200° C. to about 700° C., and the heat-treating may be performed under a pressure condition of about 5 MPa to about 300 MPa.

At least one of the first margin layer-forming composition, the second margin layer-forming composition, the first cover layer-forming composition, or the second cover layer-forming composition may include a pyrochlore crystalline material, a pyrochlore crystalline material precursor, or a combination thereof.

At least one of the first margin layer-forming composition, the second margin layer-forming composition, the first cover layer-forming composition, or the second cover layer-forming composition may further include an amorphous material, an amorphous material precursor, or a combination thereof.

The solid electrolyte-forming composition may include a garnet-type solid electrolyte, a garnet-type solid electrolyte precursor, or a combination thereof.

A weight ratio G_{La}/G_{Li} of lanthanum to lithium of at least one of the first margin layer-forming composition, the second margin layer-forming composition, the first cover layer-forming composition, or the second cover layer-forming composition may be smaller than a weight ratio G_{La}/G_{Li} of lanthanum to lithium of the solid electrolyte-forming composition.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic perspective view illustrating a structure of a multi-layered ceramic battery according to an embodiment;

FIG. 2 is a schematic cross-sectional view illustrating a structure of a multi-layered ceramic battery according to an embodiment;

FIG. 3 is a schematic cross-sectional view illustrating a structure of a multi-layered ceramic battery;

FIG. 4A is a cross-sectional view illustrating a structure of a unit cell constituting a multilayer structure;

FIG. 4B is a schematic plan view illustrating a structure of a cathode structure including a cathode layer and a first margin layer;

FIG. 4C is a schematic plan view illustrating a structure of an anode structure including an anode layer and a second margin layer;

FIG. 4D is a schematic plan view illustrating a structure of a solid electrolyte structure including a solid electrolyte layer and a third margin layer;

FIG. 4E is a schematic exploded perspective view illustrating a stacked structure of an all-solid-state battery; and

FIG. 5 shows X-ray diffraction (XRD) spectra of oxides of Example 1 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the FIGS., to explain aspects.

The terms used herein are merely used to describe specific embodiments and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification and are not intended to preclude the possibility that one or more other features, numbers, steps, actions, components, parts, ingredients, materials, or combinations thereof may exist or may be added. The symbol “/” used herein may be interpreted as “and” or “or” according to the context.

In the drawings, the thicknesses of layers and regions are exaggerated or reduced for clarity. Like reference numerals in the drawings denote like elements throughout the specification. Throughout the specification, it will be understood that when a component, such as a layer, a film, a region, or a plate, is referred to as being “on” another component, the component may be directly on the other component or intervening components may be present thereon.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “metal” includes all of metals and metalloids such as silicon and germanium in an elemental or ionic state, and the term “alloy” refers to a composite of two or more metals.

As used herein, the term “cathode active material” refers to a cathode material that may undergo lithiation and delithiation, and the term “anode active material” refers to an anode material that may undergo lithiation and delithiation.

As used herein, the terms “lithiate” and “lithiating” refer to a process of adding lithium to a cathode active material or an anode active material, and the terms “delithiate” and “delithiating” refer to a process of removing lithium from a cathode active material or an anode active material.

As used herein, the terms “charge” and “charging” refer to a process of providing electrochemical energy to a battery, and the terms “discharge” and “discharging” refer to a process of removing electrochemical energy from a battery.

As used herein, the terms “positive electrode” and “cathode” refer to an electrode at which electrochemical reduction and lithiation occur during a discharging process, and the terms “negative electrode” and “anode” as used herein refer to an electrode at which electrochemical oxidation and delithiation occur during a discharging process.

As used herein, the term “particle diameter” of particles refers to an average diameter when particles are spherical and refers to an average major axis length when particles are non-spherical. A particle diameter of particles may be measured by using a particle size analyzer (PSA). A “particle diameter” is, for example, an average particle diameter. The average particle diameter is a median particle diameter (D50) unless explicitly stated otherwise. The median particle diameter (D50) refers to a particle size corresponding to a 50% cumulative value when a particle size calculated from particles having the smallest particle size in a cumulative distribution curve of particle sizes in which particles are accumulated in order of particle sizes from the smallest particles to the largest particles. The cumulative value may be, for example, a cumulative volume. The median particle diameter (D50) may be measured, for example, through a laser diffraction method. As used herein, the term “D10” refers to an average diameter of particles having a cumulative volume of 10 vol % in a particle size distribution, and the term “D90” refers to an average diameter of particles having a cumulative volume of 90 vol % in a particle size distribution.

Alternatively, a particle size may be measured by using a scanning electron microscope. A particle size is determined as an average value of 30 or more randomly selected particles with a size of 1 μm or more, excluding fine particles. An average particle diameter of the cathode active material may be measured, for example, by using a laser diffraction method. More specifically, after the cathode active material is dispersed in a solution, the cathode active material may be introduced into a commercially available laser diffraction particle size measuring device (for example, Microtrac MT 3000) and irradiated with ultrasonic waves at about 28 KHz and an output of 60 W, and then an average particle diameter (D50) based on 50% of a particle diameter distribution in the measuring device may be calculated.

Hereinafter, an all-solid-state battery and a method of manufacturing the same according to an embodiment will be described in more detail.

The all-solid-state battery may be used in electronic devices, vehicles, and the like, but may also be suitable for other purposes. The all-solid-state battery is not particularly limited and may be, for example, a lithium-ion battery, a lithium-air battery, or the like.

The all-solid-state battery is not particularly limited and may be, for example, a multi-layered ceramic (MLC) battery. These batteries will be described in more detail below.

An all-solid-state battery according to an embodiment may include a multilayer structure, a first cover layer as a first outermost layer of the multilayer structure in a stacking direction, and a second cover layer disposed opposite the first outermost layer and stacked as a second outermost layer.

The multilayer structure may include;
a solid electrolyte layer including a solid electrolyte,
a cathode layer provided on a first side of the solid electrolyte layer, wherein a portion of the cathode layer extends to a first edge of the solid electrolyte layer,
a first margin layer provided on an area of the first side of the solid electrolyte layer including an area proximate to a second edge of the solid electrolyte opposite the first edge in which the cathode layer is absent,
an anode layer provided on an opposite second side of the solid electrolyte layer, wherein a portion of the anode layer extends to the second edge of the solid electrolyte layer, and
a second margin layer provided of an area of the second side of the solid electrolyte layer including an area proximate to the first edge of the solid electrolyte in which the anode layer is absent.

In the disclosure, a margin layer of an all-solid-state battery may refer to a peripheral portion of an electrode layer on which an electrode is not printed, may form an outer periphery of a cell, may serve to protect the inside of the cell from an external environment, and may also perform a function of insulating a cathode from an anode.

In the disclosure, a first cover layer and a second cover layer of an all-solid-state battery refer to an uppermost layer and a lowermost layer in a multilayer structure in which a cathode layer, a solid electrolyte layer, and an anode layer are sequentially stacked to form a plurality of layers, and the first cover layer and the second cover layer, together with a first margin layer and a second margin layer, form an outer periphery of a cell and serve to protect the inside of the cell from an external environment.

An all-solid-state battery according to an embodiment will be described in more detail with reference to the accompanying drawings.

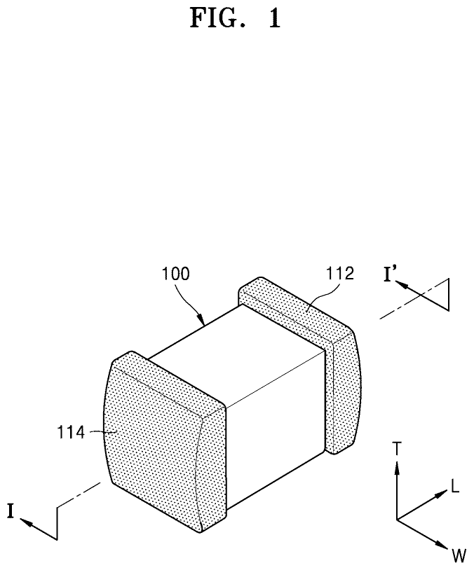

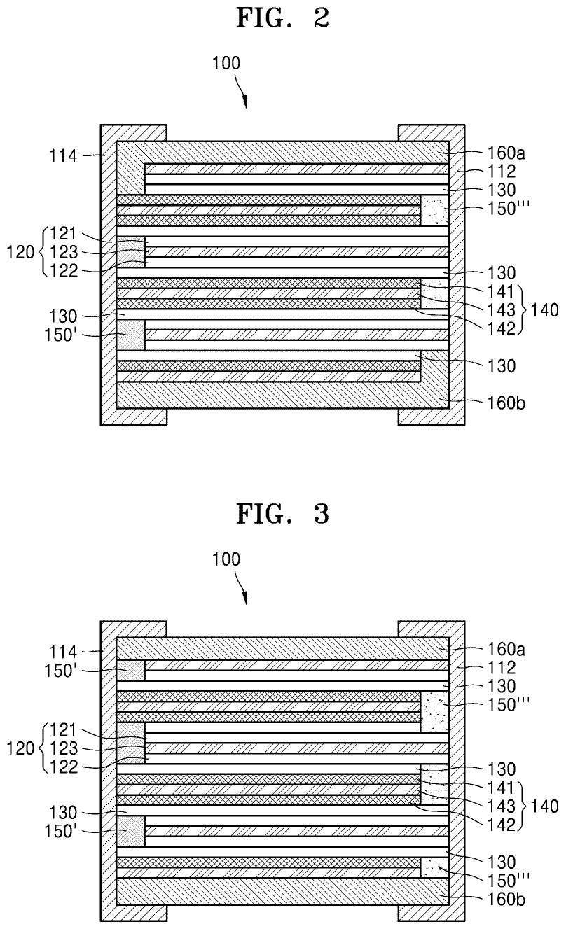

FIG. 1 is a schematic perspective view illustrating an all-solid-state battery according to an embodiment. FIGS. 2 and 3 are cross-sectional views of an all-solid-state battery according to another embodiment. The all-solid-state battery may include, for example, an MLC battery.

Referring to FIG. 1, the all-solid-state battery 100 may includes an external electrode 112 and an external electrode 114 connected thereto.

Referring to FIGS. 1, 2, and 3, in the all-solid-state battery 100, opposite sides facing each other in a thickness direction (T-axis direction) may be defined as a first side and a second side, and sides connected to the first side and the second side and facing each other in a length direction (L direction) may be defined as a third side and a fourth side.

The all-solid-state battery 100 may include a multilayer structure, a first cover layer 160a stacked as a first outermost layer of the multilayer structure in a stacking direction, and a second cover layer 160b disposed at a side opposite to the first outermost layer and stacked as a second outermost layer.

A solid electrolyte layer 130 may be disposed in the stacking direction between a cathode layer 120 and an anode layer 140. In the all-solid-state battery 100, a plurality of cathode layers 120 and a plurality of anode layers 140 may be alternately disposed in the stacking direction, and a plurality of solid electrolyte layers 130 may be disposed between the cathode layers 120 and the anode layers 140 that are alternately disposed in the stacking direction. The all-solid-state battery 100 may be manufactured by alternately arranging the plurality of cathode layers 120 and the plurality of anode layers 140 in the stacking direction, interposing the plurality of solid electrolyte layers 130 between the alternately arranged cathode layers 120 and anode layers 140 to prepare a multilayer structure which is an electrode-electrolyte stack, and collectively, sintering the multilayer structure.

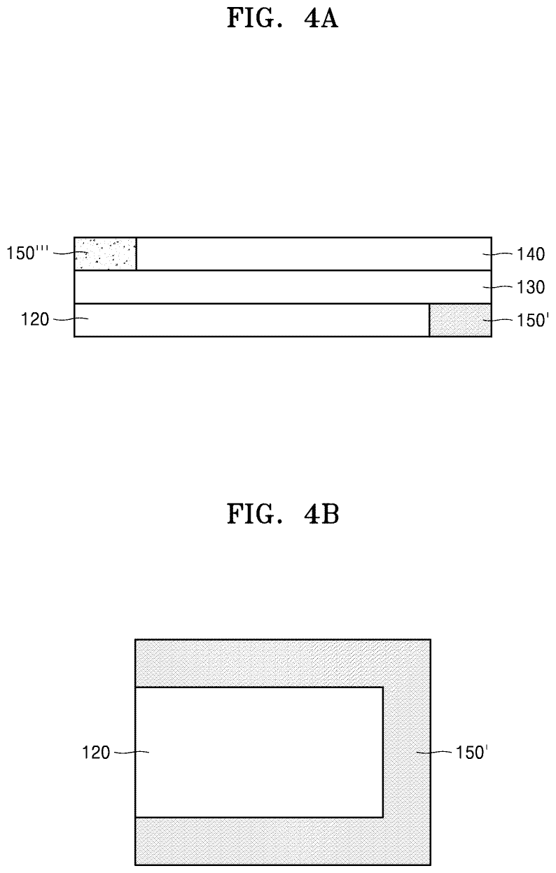

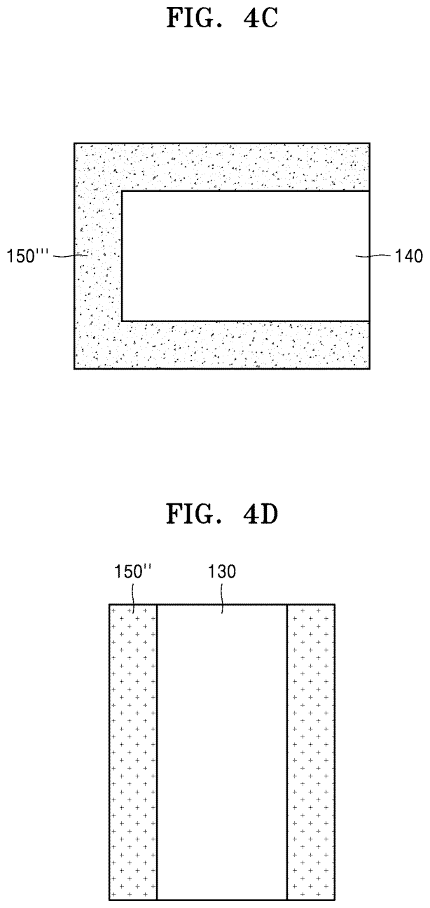

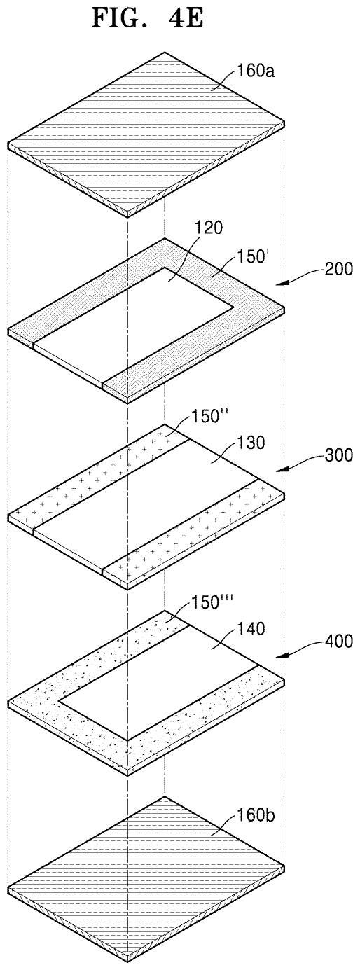

A unit cell constituting the multilayer structure may have a cross-sectional structure as shown in FIG. 4A. The unit cell may include the solid electrolyte layer 130 including a solid electrolyte, the cathode layer 120 provided on a first side of the solid electrolyte layer 130, and the anode layer 140 provided on a second side of the solid electrolyte layer 130.

A portion of the cathode layer 120 may extend to a first edge of the solid electrolyte layer 130, and a first margin layer 150′ may be provided in an area on the first side of the solid electrolyte layer, in which the cathode layer 120 is not substantially provided (see FIG. 4B). An area of the first margin layer 150′ may be in a range of about 5% to about 30% with respect to 100% of the total area of the first margin layer 150′ and the cathode layer 120. A cathode overlap area in which the first margin layer 150′ overlaps the cathode layer 120 may be in a range of 0% to about 3%, about 0.01% to about 3%, or about 0.1% to about 3% with respect to 100% of the total area of the first margin layer 150′ and the cathode layer 120. In the disclosure, an area in which the cathode layer 120 is not formed (or absent) refers to the area of the first margin layer 150′. When the area of the first margin layer 150′ is within the above range, an all-solid-state battery capable of effectively protecting internal cells from the outside and improving energy density and rate characteristics may be achieved and manufactured. The first margin layer 150′ may be disposed to be substantially coplanar with the cathode layer 120. The first margin layer 150′ may be disposed on a first side of the solid electrolyte layer 130 and essentially have a thickness substantially equal to that of the cathode layer 120.

A portion of the anode layer 140 may extend to a second edge of the solid electrolyte layer 130, and a second margin layer 150′″ may be provided in an area on the second side of the solid electrolyte layer 130, in which the anode layer 140 is not substantially provided (see FIG. 4C). An area of the second margin layer 150′″ may be in a range of about 5% to about 30% with respect to 100% of the total area of the second margin layer 150′″ and the anode layer 140. An anode overlap area in which the second margin layer 150′″ overlaps the anode layer 140 may be in a range of 0% to about 3%, about 0.01% to about 3%, or about 0.1% to about 3% with respect to 100% of the total area of the second margin layer 150′″ and the anode layer 140. In the disclosure, an area in which the anode layer 140 is not provided (or absent) refers to the area of the second margin layer 150′″. When the area of the second margin layer 150′″ is within the above range, an all-solid-state battery capable of effectively protecting internal cells from the outside and improving energy density and rate characteristics may be achieved or manufactured. The second margin layer 150′″ may be disposed to be substantially coplanar with the anode layer 140. The second margin layer 150′″ may be disposed on the second side of the solid electrolyte layer 130 and essentially have a thickness substantially equal to that of the anode layer 140.

As shown in FIGS. 2 and 3, the all-solid-state battery 100 may include a plurality of first margin layers 150′ and a plurality of second margin layers 150′″.

Among the plurality of first margin layers 150′ and the plurality of second margin layers 150′″, the first margin layer 150′ and the second margin layer 150′″ may have a structure as shown in FIG. 2. Referring to FIG. 2, cross-sectional structures of the first cover layer 160a and the second cover layer 160b may have, for example, an “L” shape.

In the all-solid-state battery 100 according to an embodiment, as shown in FIGS. 2 and 3, the first margin layer 150′ and the second margin layer 150′″ may be disposed in a zigzag pattern.

Although not shown in FIGS. 2 and 3, the all-solid-state battery 100 may optionally include a third margin layer 150″ that is disposed on an extended plane of the solid electrolyte layer 130 and has a structure that partially overlaps the first margin layer 150′ and the second margin layer 150′″ (see FIG. 4D),

An area of the third margin layer 150″ may be in a range of about 3% to about 20% with respect to 100% of the total area of the third margin layer 150″ and the solid electrolyte layer 130. If the area of the third margin layer 150″ is within the above range, an all-solid-state battery capable of effectively protecting internal cells from the outside and improving energy density and rate characteristics may be achieved.

FIG. 4E is an exploded perspective view schematically illustrating the laminated structure of an all-solid-state battery. The solid electrolyte structure (300) is arranged between a cathode structure (200) and an anode structure (400), and a first cover layer (160a) and a second cover layer (160a) are provided at both ends thereof, thereby manufacturing an all-solid-state battery.

Terminals of a cathode current collector 123 and an anode current collector 143 may be exposed at opposite sides of the multilayer structure of the all-solid-state battery 100. The exposed terminals may be connected and coupled to the external electrodes 112 and 114. The external electrode 112 connected to the exposed terminal of the cathode current collector 123 may serve as a cathode. The external electrode 114 connected to the exposed terminal of the anode current collector 143 may serve as an anode.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

The glass may include, for example, silicon oxide, boron oxide, aluminum oxide, transition metal oxide, alkali metal oxide, alkaline earth metal oxide, or a combination thereof. A transition metal included in the glass may be selected from zinc (Zn), titanium (Ti), copper (Cu), vanadium (V), manganese (Mn), iron (Fe), and
nickel (Ni), an alkali metal may be selected from lithium (Li), sodium (Na), or potassium (K), and an alkaline earth metal may be selected from magnesium (Mg), calcium (Ca), strontium (Sr), or barium (Ba).

The cathode layer 120 may include a cathode active material. For example, the cathode layer 120 may include the cathode current collector 123 and a cathode active material layer 121 or 122 disposed on one side or opposite sides of the cathode current collector 123.

Any cathode active material may be used without limitation as long as the cathode active material may be commonly used in all-solid-state batteries. As the cathode active material, a compound (lithiated intercalation compound) capable of reversibly intercalating and deintercalating lithium may be used. Specifically, at least one composite oxide of lithium and a metal selected from cobalt, manganese, nickel, and a combination thereof may be used. The composite oxide may be lithium transition metal composite oxide, and specific examples thereof may include lithium nickel-based oxide, lithium cobalt-based oxide, lithium manganese-based oxide, a lithium iron phosphate-based compound, cobalt-free nickel-manganese-based oxide, or a combination thereof. As an example, a compound represented by any one of formulas below may be used: LiₐA_{1-b}X_{b}O_{2-c}D_{c}, wherein 0.90≤a≤1.8, 0≤b≤0.5, and 0≤c≤0.05; LiₐMn_{2-b}X_{b}O_{4-c}D_{c}, wherein 0.90≤a≤1.8, 0≤b≤0.5, and 0≤c≤0.05; LiₐNi_{1-b-c}CO_{b}X_{c}O_{2-α}D_{α}, wherein 0.90≤a≤1.8, 0≤b≤0.5, and 0≤c≤0.5, 0<α<2; LiₐNi_{1-b-c}Mn_{b}X_{c}O_{2-α}D_{α}, wherein 0.90≤a≤1.8, 0≤b≤0.5, 0≤c≤0.5, and 0<α<2; LiₐNi_{b}Co_{c}L¹_{d}GₑO₂, wherein 0.90≤a≤1.8, 0≤b≤0.9, 0≤c≤0.5, 0≤d≤0.5, and 0≤e≤0.1; LiₐNiG_{b}O₂, wherein 0.90≤a≤1.8 and 0.001≤b≤0.1; LiₐCoG_{b}O₂, wherein 0.90≤a≤1.8 and 0.001≤b≤0.1; LiₐMn_{1-b}G_{b}O₂, wherein 0.90≤a≤1.8 and 0.001≤b≤0.1; LiₐMn₂G_{b}O₄, wherein 0.90≤a≤1.8 and 0.001≤b≤0.1; LiₐMn_{1-g}G_{g}PO₄, wherein 0.90≤a≤1.8 and 0≤g≤0.5; Li_{(3-f)}Fe₂(PO₄)₃, wherein 0≤f≤2; and LiₐFePO₄, wherein 0.90≤a≤1.8.

In the above formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

The cathode active material layer 121 or 122 may additionally include a binder, a conductive material, or a combination thereof. Representative examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, polyester resin, nylon, and the like, but one or more embodiments are not limited thereto.

The conductive material may include, for example, a carbon-based conductive material. The carbon-based conductive material may include, for example, carbon black (CB), carbon fiber, graphite, fluorinated carbon, or a combination thereof. The CB may be, for example, acetylene black (AB), Ketjen black (KB), super P carbon, channel black, furnace black (FB), lamp black, thermal black, or a combination thereof. The graphite may be natural graphite or artificial graphite. The cathode active material layers 121 and 122 may further include a metal-based conductive material, a metal oxide-based conductive material, or a polymer-based conductive material in addition to the carbon-based conductive material described above. The metal-based conductive material, the metal oxide-based conductive material, or the polymer-based conductive material may be, for example, metal fiber; a metal powder such as an aluminum powder or a nickel powder; a conductive metal oxide such as zinc oxide or potassium titanate; or a polyethylene derivative.

Anode active material layers 141 and 142 may include an anode active material. The anode active material may include, for example, at least one of lithium metal phosphate, lithium metal oxide, metal oxide, or a carbon-based anode active material.

The carbon-based anode active material may include, for example, amorphous carbon, crystalline carbon, porous carbon, or a combination thereof. The crystalline carbon may include, for example, graphite such as non-shaped, plated shaped, flake-shaped, spherical, or fibrous natural graphite or artificial graphite.

The amorphous carbon may include, for example, CB, AB, FB, KB, graphene, soft carbon or hard carbon, mesophase pitch carbide, calcined coke, or the like. The amorphous carbon may be carbon that has no crystallinity or very low crystallinity and is distinguished from crystalline carbon.

The carbon-based anode active material may be, for example, porous carbon. A pore volume of the porous carbon may be, for example, in a range of about 0.1 cm³/g to about 10.0 cm³/g, about 0.5 cm³/g to about 5 cm³/g, or about 0.1 cm³/g to about 1 cm³/g. An average pore diameter of the porous carbon may be, for example, in a range of about 1 nm to about 50 nm, about 1 nm to about 30 nm, or about 1 nm to about 10 nm. A Brunauer-Emmett-Teller (BET) specific surface area of the porous carbon may be, for example, in a range of about 100 m²/g to about 3,000 m²/g.

The anode active material may be, for example, a compound selected from Li_{4/3}Ti_{5/3}O₄, LiTiO₂, LiM1ₛM2ₜOᵤ, wherein M1 and M2 are transition metals, and s, t, and u are any positive numbers), TiOₓ, wherein 0<x≤3, and LiₓV₂(PO₄)₃, wherein 0<x≤5. The anode active material according to an embodiment may include Li_{4/3}Ti_{5/3}O₄, LiTiO₂, or a combination thereof.

The anode active material layers 141 and 142 may contain a conductive material, a binder, or a combination thereof. The conductive material and binder of the anode active material layers 141 and 142 may be the same as the conductive material and binder of the cathode active material layer 121 and 122.

The cathode current collector 123 and the anode current collector 143 may consist of, for example, a metal selected from copper, aluminum, nickel, silver, gold, platinum, and an alloy thereof, a conductive oxide, or a combination thereof.

The solid electrolyte layer 130 may include an oxide-based solid electrolyte.

The oxide-based solid electrolyte may be, for example, a garnet-type solid electrolyte. A solid electrolyte may be prepared, for example, through sintering or the like.

A material having a garnet-phase crystal structure (cubic phase) may include, for example, a compound represented by Formula 3.

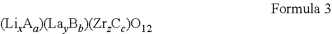

In Formula 3, A may be a monovalent, divalent, or trivalent cation, or a combination thereof, B may be a monovalent, divalent, or trivalent cation, or a combination thereof, C may be a monovalent, divalent, trivalent, tetravalent, pentavalent, or hexavalent cation, or a combination thereof, 6≤x≤8, 0≤a≤2, 2≤y≤3, 0≤b≤1, 0<z≤2, and 0≤c≤2.

In Formula 3, the monovalent cation in A, B, and C may include at least one of Li, Na, or K. The divalent to hexavalent cations may include, for example, at least one of Mg, Ca, Sr, Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Cu, Ag, Au, Zn, Cd, Hg, Al, Ga, In, Tl, Ge, Sn, Pb, Sb, Bi, Po, As, Se, and Te.

In Formula 3, 6.1≤x≤8, 6.3≤x≤8, 6.5≤x≤8, or 6.7≤x≤8, and 0≤a≤2, 0.5≤a≤1.8, 0.7≤a≤1.8, or 1≤a≤2.

In Formula 3, 2≤y≤3, 2.3≤y≤3, 2.5≤y≤3, or 2.7≤y≤3, and 0≤b≤1, 0.3≤b≤1, 0.5≤b≤1, or 0.7≤b≤1.

In Formula 3, 0<z≤2, 0.3≤z≤2, 0.5≤z≤2, or 0.7≤z≤2, and 0≤c≤2, 0≤c≤0.7, 0≤c≤0.5, or 0≤c≤0.3.

The compound of Formula 3 may may contain a compound represented by Formula 4.

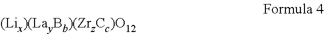

In Formula 4, B may be at least one of calcium (Ca), strontium (Sr), cesium (Cs), or barium (Ba), C may be at least one of aluminum (Al), tungsten (W), niobium (Nb), or tantalum (Ta), 6≤x≤8, 2≤y≤3, 0<z≤2, 0<b≤1, and 0.01≤c≤20.

An electrolyte having a garnet-phase crystal structure (cubic phase) according to an embodiment may include, for example, Li₇La₃Zr₂O₁₂ (LLZO), Li_{6.5}La₃Zr_{1.5}Ta_{0.5}O₁₂, Li_{6.5}La₃Zr_{1.5}Nb_{0.5}O₁₂, Li_{6.25}La₃Zr₂Al_{0.25}O₁₂, or the like.

According to another embodiment, the electrolyte having a garnet-phase crystal structure (cubic phase) may include LixLa₃M₂O₁₂, wherein 6≤x≤8, and M=Ta, Nb, or Zr, LixLa₃Zr_{2-α}M_{α}O₁₂, wherein 6≤x≤8, and M=Ta or Nb, Li_{6.24}La₃Zr₂Al_{0.24}O₁₂, Li₇La₃Zr_{1.7}W_{0.3}O₁₂, Li_{4.9}La_{2.5}Ca_{0.5}Zr_{1.7}Nb_{0.3}O₁₂, Li_{6.4}La₃Zr_{1.7}W_{0.3}O₁₂, Li₇La₃Zr_{1.5}W_{0.5}O₁₂, Li₇La₃Zr_{1.5}Nb_{0.5}O₁₂, Li₇La₃Zr_{1.5}Ta_{0.5}O₁₂, Li₇La_{2.75}Ca_{0.25}Zr_{1.75}Nb_{0.25}O₁₂, Li_{6.272}La₃Zr_{1.7}W_{0.3}O₁₂, or the like.

The solid electrolyte layer 130 may further include an amorphous electrolyte in addition to the oxide-based solid electrolyte. The amorphous material may be flexible to connect particles of the oxide-based solid electrolyte or fill pores. By having such a structure, an oxide with excellent density may be prepared.

The amorphous electrolyte may include a glass-based material having a glass transition phenomenon. For example, an amorphous electrolyte may include lithium (Li), oxygen (O), and at least one of germanium (Ge), silicon (Si), boron (B), and phosphorus (P), and specifically, the amorphous electrolyte may be glass including Li₂O and at least one of GeO₂, SiO₂, B₂O₃, and P₂O₅. For example, the amorphous electrolyte may include Li, B, Si, and O, and may be, for example, glass including SiO₂, B₂O₃, and Li₂O. Here, the glass refers to a material that is crystallographically amorphous in X-ray diffraction or electron diffraction.

When the amorphous electrolyte includes Li₂O, a content of Li₂O may be in a range of about 20 mol % to about 75 mol %, about 25 mol % to about 75 mol %, about 30 mol % to about 75 mol %, about 40 mol % to about 75 mol %, or about 50 mol % to about 75 mol %. When the amorphous electrolyte includes SiO₂, a content of SiO₂ may be in a range of more than about 0 mol % to about 70 mol %, about 5 mol % to about 50 mol %, or about 10 mol % to about 30 mol %. If the amorphous electrolyte includes B₂O₃, a content of B₂O₃ may be in a range of more than 0 mol % to about 80 mol %, about 5 mol % to about 80 mol %, about 10 mol % to about 60 mol %, or about 20 mol % to about 50 mol %. In addition, a content of each oxide in the amorphous electrolyte may be a content of each oxide with respect to the total content of respective oxides, and specifically, a ratio of the content (mol) of each oxide to the total amount (mol) of Li₂O and at least one of SiO₂, B₂O₃, and P₂O₅ may be a percentage (mol %). The content of each oxide may be measured by using inductively coupled plasma atomic emission spectrometry (ICP-AES).

The amorphous oxide may further include additive elements as needed.

Examples of the additive elements may include at least one of sodium (Na), magnesium (Mg), aluminum (Al), potassium (K), calcium (Ca), titanium (Ti), vanadium (V), chromium (Cr), manganese (Mn), iron (Fe), cobalt (Co), nickel (Ni), copper (Cu), zinc (Zn), gallium (Ga), selenium (Se), rubidium (Rb), sulfur(S), yttrium (Y), zirconium (Zr), niobium (Nb), molybdenum (Mo), silver (Ag), indium (In), tin (Sn), antimony (Sb), cesium (Cs), barium (Ba), hafnium (Hf), tantalum (Ta), tungsten (W), lead (Pb), bismuth (Bi), gold (Au), lanthanum (La), neodymium (Nd), or europium (Eu). An oxide glass-based material may include at least one selected from these additive elements as an oxide.

An solid electrolyte may include Li, La, Zr, Ta, O, B, and Si. B and/or Si may be derived from an oxide.

The solid electrolyte may include an oxide containing lanthanum, zirconium, tantalum, lithium, boron, and silicon, and may include an oxide in which a weight ratio G_{La}/G_{Li} of lanthanum to lithium is in a range of about 6 to about 15. Specifically, in the solid electrolyte, the weight ratio G_{La}/G_{Li} of lanthanum to lithium may be in a range of about 6.0 to about 10.0, about 7.0 to about 10.0, or about 8.0 to about 10.0. For example, based on 100 parts by weight of the oxide, a content of lanthanum may be in a range of about 40 parts by weight to about 60 parts by weight, and a content of lithium may be in a range of about 1 part by weight to about 8 parts by weight. The content of lanthanum and lithium and the weight ratio of lanthanum to lithium may be evaluated through inductively coupled plasma (ICP) analysis.

The solid electrolyte layer 130 may further include a binder. The binder may be selected from binders used in the cathode active material layers 121 and 122. A content of the binder used in the solid electrolyte layer 130 may be selected from contents of the binders used in the cathode active material layers 121 and 122. The binder may be removed by being partially or entirely vaporized and/or carbonized during a sintering process of the solid electrolyte layer 130. The binder may be omitted.

At least one of the first cover layer, the second cover layer, the first margin layer 150′, and the second margin layer 150′″ may contain an oxide including a pyrochlore crystalline material. In addition, the third margin layer 150″ may contain an oxide including a pyrochlore crystalline material.

A margin layer and a cover layer should have extremely low ionic conductivity and electronic conductivity to minimize self-discharge of a battery during storage and should have high stability against an external environment. In addition, the margin layer and/or the cover layer may have high compatibility in a battery manufacturing process. Specifically, an MLC battery may be formed by simultaneously sintering a first cover layer, a cathode, a first margin layer, an electrolyte, a third margin layer, an anode, a second margin layer, and a second cover layer. Therefore, the margin layer and/or the cover layer may have similar behavior to other battery components (solid electrolyte or the like) in a battery manufacturing environment. For example, the margin layer and/or the cover layer may be sintered and formed at the same temperature and pressure as a temperature and pressure at which a solid electrolyte is formed. If the margin layer and/or the cover layer are not formed to have sufficient density, low ionic conductivity, or the like at the temperature and pressure at which the solid electrolyte is formed, it is difficult to expect high performance (stability or the like) of a battery.

A pyrochlore crystalline material may be sintered and formed at the same temperature and pressure as a garnet crystalline material. For example, the pyrochlore crystalline material and the garnet crystalline material may be formed by heat-treating respective raw materials under conditions of a temperature of about 200° C. to about 700° C. and a pressure of about 5 MPa to about 300 MPa. Therefore, the margin layer and/or the cover layer according to an embodiment may have excellent compatibility in a battery manufacturing process using a garnet-type solid electrolyte.

A pyrochlore crystalline material may have a higher density than a garnet crystalline material sintered and may be formed at similar or the same temperature and pressure. Therefore, the margin layer and/or the cover layer according to an embodiment may have high stability against a solvent and a binder during a battery manufacturing process. In addition, the margin layer and/or the cover layer according to an embodiment may effectively protect internal cells from an external environment such as moisture. In particular, the margin layer and/or the cover layer according to an embodiment may increase the stability of a battery including a garnet-type solid electrolyte.

The margin layer and/or the cover layer according to an embodiment may have a density of 90% or more, about 93% to about 99.5%, about 93.5% to about 99%, or about 93.7% to about 97.2%. In the present specification, the term “density” refers to a density calculated by measuring the dimensions (diameter and thickness) and mass of a sintered bod. The density may be a relative density. The density may be determined as a ratio of a measured density to a theoretical density of the sintered body. The measured density may be obtained by using a densitometer based on Archimedes' principle, for example, a pycnometer, and the theoretical density of the sintered body may be calculated by using theoretical densities of constituent raw materials or substances.

The pyrochlore crystalline material may have sufficiently low ionic conductivity and sufficiently low electronic conductivity. The margin layer and/or the cover layer according to an embodiment may have an ionic conductivity of 1.0×10⁻⁸ S/cm or less or about 1.0×10⁻¹⁰ S/cm to about 1.0×10⁻⁸ S/cm.

The pyrochlore crystalline material may have lower ionic conductivity than a garnet crystalline material. Therefore, the margin layer and/or the cover layer according to an embodiment may have lower ionic conductivity than the solid electrolyte. In the all-solid-state battery 100 according to an embodiment, the ionic conductivity of the solid electrolyte may be 100 times or more, for example, about 100 to about 1,000 times the ionic conductivity of the margin layer and/or the cover layer. The margin layer and the cover layer according to an embodiment may substantially prevent self-discharge of a battery including a garnet-type solid electrolyte.

The margin layer and/or the cover layer according to an embodiment may have an electrical conductivity of less than 1.0×10⁻⁷ S/cm, 1.0×10⁻⁸ S/cm or less, or about 1.0×10⁻⁹ S/cm to about 1.0×10⁻⁸ S/cm.

The pyrochlore crystalline material may be a lithium-free material and may contain a compound represented by Formula 1.

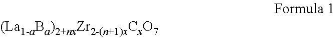

In Formula 1, B may be one or more trivalent cations, C may be a one or more tetravalent, one or more pentavalent, or one or more hexavalent cation, 0≤a<1, and 0≤x<0.66.

$$n = ( oxidation number of C ) - ( oxidation number of Zr ) .$$

In Formula 1, the oxidation number of Zr may be, for example, 4.

In Formula 1, B may be at least one of scandium (Sc), yttrium (Y), aluminum (Al), gallium (Ga), or indium (In).

In Formula 1, C may be at least one of tungsten (W), niobium (Nb), bismuth (Bi), antimony (Sb), or tantalum (Ta).

In B and C of Formula 1, the trivalent to hexavalent cations may include, for example, at least one of Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Ag, Au, Cd, Al, Ga, In, Tl, Ge, Sn, Pb, Sb, Bi, Po, As, S, and Te.

In Formula 1, 0≤<1, 0≤a<0.8, 0≤a<0.5, or 0≤a<0.3.

In Formula 1, 0≤x<0.66, 0≤x<0.5, or 0≤x<0.4.

The pyrochlore crystalline material may contain a compound represented by Formula 2.

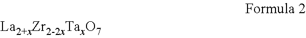

In Formula 2, 0≤x<0.66.

For example in Formula 2, 0≤x<0.5 or 0≤x<0.4.

The pyrochlore crystalline material may be a lithium-free phase, for example, La₂₊ₓZr₂₋₂ₓTaₓO₇, wherein 0≤x<0.66.

The margin layer and/or the cover layer according to an embodiment may exhibit peaks in an X-ray diffraction (XRD) spectrum at diffraction angles 2θ of about 27.5° to about 29°, about 32° to about 33.5°, about 46.5° to about 48°, and about 55° to about 56.5°. These peaks may correspond to the pyrochlore-phase crystalline material.

The margin layer and/or the cover layer according to an embodiment may further include an amorphous oxide in addition to the pyrochlore crystalline material. The amorphous material may be flexible to connect the particle of the pyrochlore crystalline material or fill pores. By having such a structure, an oxide with excellent density may be prepared.

The amorphous oxide may include a glass-based material having a glass transition phenomenon. For example, the amorphous oxide may include lithium (Li), oxygen (O), and at least one of germanium (Ge), silicon (Si), boron (B), and phosphorus (P), and specifically, the amorphous oxide may be glass including Li₂O and at least one of GeO₂, SiO₂, B₂O₃, or P₂O₅. For example, the amorphous oxide may include Li, B, Si, and/or O, and may be glass including, for example, SiO₂, B₂O₃, and/or Li₂O. Here, the glass refers to a material that is crystallographically amorphous in X-ray diffraction or electron diffraction.

If the amorphous oxide includes Li₂O, a content of Li₂O may be in a range of about 20 mol % to about 75 mol %, about 25 mol % to about 75 mol %, about 30 mol % to about 75 mol %, about 40 mol % to about 75 mol %, or about 50 mol % to about 75 mol %. If the amorphous oxide includes SiO₂, a content of SiO₂ may be in a range of more than 0 mol % to about 70 mol %, about 5 mol % to about 50 mol %, or about 10 mol % to about 30 mol %. If the amorphous oxide includes B₂O₃, a content of B₂O₃ may be in a range of more than 0 mol % to about 80 mol %, about 5 mol % to about 80 mol %, about 10 mol % to about 60 mol %, or about 20 mol % to about 50 mol %. In addition, a content of each oxide in the amorphous oxide may be a content of each oxide with respect to the total content of respective oxides, and specifically, a ratio of the content (mol) of each oxide to the total amount (mol) of Li₂O and at least one of SiO₂, B₂O₃, or P₂O₅ may be a percentage (mol %). The content of each oxide may be measured by using ICP-AES.

The amorphous oxide may further include additive elements as needed. Examples of the additive elements may include at least one of sodium (Na), magnesium (Mg), aluminum (Al), potassium (K), calcium (Ca), titanium (Ti), vanadium (V), chromium (Cr), manganese (Mn), iron (Fe), cobalt (Co), nickel (Ni), copper (Cu), zinc (Zn), gallium (Ga), selenium (Se), rubidium (Rb), sulfur(S), yttrium (Y), zirconium (Zr), niobium (Nb), molybdenum (Mo), silver (Ag), indium (In), tin (Sn), antimony (Sb), cesium (Cs), barium (Ba), hafnium (Hf), tantalum (Ta), tungsten (W), lead (Pb), bismuth (Bi), gold (Au), lanthanum (La), neodymium (Nd), or europium (Eu). An oxide glass-based material may include at least one selected from these additive elements as an oxide.

The margin layer and/or the cover layer may include a material including Li, La, Zr, Ta, and/or O, or may include Li, La, Zr, Ta, O, B, and/or Si. The lithium may originate from an amorphous oxide.

The margin layer and/or the cover layer may include an oxide containing lanthanum, zirconium, tantalum, lithium, boron, and silicon, wherein a content of lanthanum may be in a range of about 25 parts by weight to about 40 parts by weight, a content of lithium may be in a range of about 6 parts by weight to about 10 parts by weight, a content of zirconium may be in a range of about 8 parts by weight to about 15 parts by weight, a content of tantalum may be in a range of about 5 parts by weight to about 8 parts by weight, a content of boron may be in a range of about 4 parts by weight to about 6 parts by weight, and a content of silicon may be in a range of about 1 part by weight to about 3 parts by weight. A weight ratio of each component constituting an oxide may be evaluated through ICP analysis.

The margin layer and/or the cover layer may include an oxide in which a weight ratio G_{La}/G_{Li} of lanthanum to lithium is in a range of about 3 to about 5. For example, a content of lanthanum may be in a range of about 25 parts by weight to about 40 parts by weight, and a content of lithium may be in a range of about 6 parts by weight to about 10 parts by weight. Specifically, the weight ratio G_{La}/G_{Li} of lanthanum to lithium may be in a range of about 3.05 to about 4.99, about 3.1 to about 4.99, or about 3.14 to about 4.96. The content of lanthanum and lithium and the weight ratio of lanthanum to lithium may be evaluated through ICP analysis.

The weight ratio G_{La}/G_{Li} of lanthanum to lithium in the margin layer and/or the cover layer may be smaller than that of the weight ratio G_{La}/G_{Li} of the solid electrolyte.

A content of a pyrochlore phase may be in a range of about 90 parts by weight to about 99.5 parts by weight, about 95 parts by weight to about 99 parts by weight, or about 97 parts by weight to about 99 parts by weight with respect to 100 parts by weight of the total content of oxides in the margin layer and/or the cover layer. A content of the amorphous material may be in a range of about 0.5 wt % to about 10 wt % about 1 wt % to about 5 wt %, or about 1 wt % to about 3 wt % with respect to 100 parts by weight of the total content of the oxides in the margin layer and/or the cover layer. The content or mixing ratio of the pyrochlore phase in the oxides for the margin layer and/or the cover layer may be confirmed through XRD analysis or transmission electron microscopy/selected area electron diffraction (TEM/SAED). Through XRD analysis, a dominantly maintained crystal phase may be selected, and XRD Rietveld analysis may be performed to determine a mixing ratio of each crystal phase.

A method of manufacturing an all-solid-state battery according to an embodiment is as follows. A method of manufacturing an MLC battery among all-solid-state batteries is as follows.

The method may include:
preparing a cathode structure such that the cathode structure formed has a first margin layer-forming composition that does not overlap a cathode layer;
preparing an anode structure such that the anode structure formed has a second margin layer-forming composition that does not overlap an anode layer;
forming a multilayer structure such that a solid electrolyte-forming composition is disposed between the cathode structure and the anode structure;
providing a first cover layer-forming composition on a first outermost layer of the multilayer structure; and
providing a second cover layer-forming composition on a second outermost layer of the multilayer structure, the second outermost layer disposed at a side opposite the first outermost layer of the multilayer structure to provide a stack.

The solid electrolyte-forming composition may be applied and dried to form a film form. For example, the solid electrolyte-forming composition may be applied onto a substrate and dried to prepare a solid electrolyte precursor film.

The cathode structure and/or the anode structure may be prepared on the solid electrolyte precursor film. Specifically, the multilayer structure may be prepared by:
preparing a cathode structure formed on a first solid electrolyte precursor film such that a first margin layer-forming composition does not overlap a cathode-forming composition;
preparing an anode structure formed on a second solid electrolyte precursor film such that a second margin layer-forming composition does not overlap an anode-forming composition; and
interposing the first solid electrolyte precursor film or the second solid electrolyte precursor film between the cathode structure and the anode structure.

The solid electrolyte-forming composition may be provided only on a portion of the substrate. For example, the first solid electrolyte precursor film and/or the second solid electrolyte precursor film may further include a third margin layer-forming composition in an area in which the solid electrolyte-forming composition is not provided (absent). The third margin layer-forming composition may be provided to partially overlap the first margin layer-forming composition and/or the second margin layer-forming composition in the stack to be described below.

If the solid electrolyte precursor film has a free-standing state, the substrate may be omitted.

The cathode structure may be formed on one side of the first solid electrolyte precursor film. The cathode structure may include the cathode-forming composition and the first margin layer-forming composition.

The cathode-forming composition may be provided only on a portion of one side of the first solid electrolyte precursor film. For example, the cathode-forming composition may be provided to extend to a first edge of the first solid electrolyte precursor film.

The cathode-forming composition may be provided, i.e., applied once, or applied two or more times on one side of the first solid electrolyte precursor film. For example, the cathode-forming composition may be provided once on the first solid electrolyte precursor film. Alternatively, after the cathode-forming composition is provided once on the first solid electrolyte precursor film, a cathode current collector composition may be provided thereon, and the cathode-forming composition may be provided again on the cathode current collector composition. In this case, the cathode structure may have a form in which the substrate, the first solid electrolyte precursor film, the cathode-forming composition, the cathode current collector composition, and the cathode-forming composition are sequentially stacked.

The first margin layer-forming composition may be provided on one side of the first solid electrolyte precursor film on which the cathode-forming composition is provided. The first margin layer-forming composition may be provided only on a portion of one side of the first solid electrolyte precursor film and may be provided not to substantially overlap the cathode-forming composition. The first margin layer-forming composition may be provided to have a thickness that is essentially equal to a thickness of the cathode-forming composition. For example, the first margin layer-forming composition may be provided to have a thickness equal to the sum of thicknesses of the cathode-forming composition, the cathode current collector composition, and the cathode-forming composition.

Separately, the anode structure may be formed on one side of the second solid electrolyte precursor film. The anode structure may include the anode-forming composition and the second margin layer-forming composition.

The anode-forming composition may be provided only on a portion of the second solid electrolyte precursor film. For example, the anode-forming composition may be provided to extend to a second edge of the second solid electrolyte precursor film.

The anode-forming composition may be provided, i.e., applied once, or applied two or more times on one side of the second solid electrolyte precursor film. For example, the anode-forming composition may be provided once on the second solid electrolyte precursor film. Alternatively, after the anode-forming composition is provided once on the second solid electrolyte precursor film, an anode current collector composition may be provided thereon, and the anode-forming composition may be provided again on the anode current collector composition. In this case, the anode structure may have a form in which a substrate, the second solid electrolyte precursor film, the anode-forming composition, the anode current collector composition, and the anode-forming composition are sequentially stacked.

The second margin layer-forming composition may be provided on one side of the second solid electrolyte precursor film on which the anode-forming composition is provided. The second margin layer-forming composition may be provided only on a portion of one side of the second solid electrolyte precursor film and may be provided not to substantially overlap the anode-forming composition. The second margin layer-forming composition may be provided to have a thickness that is essentially equal to a thickness of the anode-forming composition. For example, the second margin layer-forming composition may be provided to have a thickness equal to the sum of thicknesses of the anode-forming composition, the anode current collector composition, and the anode-forming composition.

The substrate may be separated and removed from a stack of the substrate, the first solid electrolyte precursor film, and the cathode structure. The substrate may be separated and removed from a stack of the substrate, the second solid electrolyte precursor film, and the anode structure.

The first solid electrolyte precursor film or the second solid electrolyte precursor film may be stacked to be disposed between the cathode structure and the anode structure, thereby forming the multilayer structure. For example, the multilayer structure may include a structure including the anode structure, the first solid electrolyte precursor film, and the cathode structure.

The stack may be prepared by providing the first cover layer-forming composition on the first outermost layer of the multilayer structure and providing the second cover layer-forming composition on the second outermost layer of the multilayer structure disposed at a side opposite to the first outermost layer of the multilayer structure. The stack may have a structure of the first cover layer-forming composition, the cathode structure, the solid electrolyte-forming composition, the anode structure. The process can be repeated one or more time to form a stack with multiple layer structures. For example one can repeat the cathode structure, the solid electrolyte-forming composition, the anode structure, and eventually end with the second cover layer-forming composition.

Optionally, the stack may be pressed before or after heat-treating. In additionally, the stack may be optionally cut before or after heat-treating. Here, a cutting size may vary according to the capacity of the MLC battery, and for example, the stack may be cut to a size of a width of about 5 mm to about 15 mm, for example, 10 mm, and a length of about 5 mm to about 15 mm, for example, 10 mm. Such a cutting process may be omitted.

An internal electrode 112 and an external electrode 114 may be formed on the stack obtained through such a process, thereby manufacturing the MLC battery according to an embodiment.

The external electrodes 112 and 114 may be formed, for example, by dipping the stack into a conductive paste including a conductive metal and glass. The external electrodes 112 and 114 may be formed, for example, by printing a conductive paste on a surface of the stack through a screen printing method or a gravure printing method. The external electrodes 111 and 114 may be formed, for example, by applying a conductive paste on the surface of the stack or transferring a dried film of a conductive paste onto the stack.

The solid electrolyte-forming composition may include an element capable of forming a garnet-type material and a content thereof. Specifically, the solid electrolyte-forming composition may include a garnet-type solid electrolyte of Formula 3 or may include an element for forming the garnet-type solid electrolyte of Formula 3 in an appropriate content (garnet-type solid electrolyte precursor).

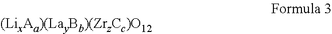

In Formula 3,
A may be a monovalent, divalent, or trivalent cation, or a combination thereof,
B may be a monovalent, divalent, or trivalent cation, or a combination thereof,
C may be a monovalent, divalent, trivalent, tetravalent, pentavalent, or hexavalent cation, or a combination thereof, 6≤x≤8, 0≤a≤2, 2≤y≤3, 0≤b≤1, 0<z≤2, and 0≤c≤2.

For example, a may be 0, b may be 0, and C may be tantalum.

The solid electrolyte-forming composition may be prepared by mixing a lithium precursor, a lanthanum precursor, a zirconium precursor, and a C element-containing precursor in a ratio that allows formation of a garnet-type electrolyte, and mechanochemically synthesizing the mixture.

The lithium precursor, the lanthanum precursor, the zirconium precursor, and the C element-containing precursor may each include an oxide, a sulfate, a chloride, or a combination thereof, each containing lithium, lanthanum, zirconium, and a C element. The lithium precursor may include, for example, Li₂O, LiCl, LiOH, Li₂(CO₃), or the like. The lanthanum precursor may include, for example, La₂O₃, LaCl₃, or the like, and the zirconium precursor may include, for example, ZrO₂, ZrCl₂, or the like. The C element-containing may be tantalum precursor, and the tantalum precursor may include, for example, Ta₂O₅, TaCl₅, or the like.

The solid electrolyte-forming composition may further include a material that forms an amorphous electrolyte.

The amorphous electrolyte may include Li, B, Si, and O, and may be, for example, glass including SiO₂, B₂O₃, and Li₂O. Here, the glass refers to a material that is crystallographically amorphous in X-ray diffraction or electron diffraction.

If the amorphous electrolyte includes Li₂O, a content of Li₂O may be in a range of about 20 mol % to about 75 mol %, about 25 mol % to about 75 mol %, about 30 mol % to about 75 mol %, about 40 mol % to about 75 mol %, or about 50 mol % to about 75 mol %. If the amorphous electrolyte includes SiO₂, a content of SiO₂ may be in a range of more than 0 mol % to about 70 mol %, about 5 mol % to about 50 mol %, or about 10 mol % to about 30 mol %. If the amorphous electrolyte includes B₂O₃, a content of B₂O₃ may be in a range of more than 0 mol % to about 80 mol %, about 5 mol % to about 80 mol %, about 10 mol % to about 60 mol %, or about 20 mol % to about 50 mol %. In addition, a content of each oxide in the amorphous electrolyte may be a content of each oxide with respect to the total content of respective oxides, and specifically, a ratio of the content (mol) of each oxide to the total amount (mol) of Li₂O and at least one of SiO₂, B₂O₃, and P₂O₅ may be a percentage (mol %).

Specifically, the solid electrolyte-forming composition may include a material for forming a garnet-type solid electrolyte and a material for forming an amorphous electrolyte. The solid electrolyte-forming composition may be in an amorphous phase. The solid electrolyte-forming composition may include a La precursor (for example, La₂O₃), a Li precursor (for example, Li₂O), a Zr precursor (for example, ZrO₂), a Ta precursor (for example, Ta₂O₅), a Si precursor (for example, SiO₂), and a B precursor (for example, B₂O₃). The solid electrolyte-forming composition may be prepared by mixing a La precursor (for example, La₂O₃), a Li precursor (for example, Li₂O), a Zr precursor (ZrO₂), a Ta precursor (Ta₂O₅), a Si precursor (SiO₂), and a B precursor (B₂O₃) in a desired ratio, and mechanochemically synthesizing the mixture.

The solid electrolyte-forming composition may include lanthanum and lithium in a weight ratio G_{La}/G_{Li} of about 6 to about 15. Specifically, in the solid electrolyte-forming composition, the weight ratio G_{La}/G_{Li} of lanthanum to lithium may be in a range of about 6.0 to about 10.0, about 7.0 to about 10.0, or about 8.0 to about 10.0. For example, in the solid electrolyte-forming composition, a content of lanthanum may be in a range of about 40 parts by weight to about 60 parts by weight, and a content of lithium may be in a range of about 1 part by weight to about 8 parts by weight. The content of lanthanum and lithium and the weight ratio of lanthanum to lithium may be evaluated through ICP analysis.

The solid electrolyte-forming composition may further include a binder.

The solid electrolyte-forming composition may further include a sintering aid.

A mechanochemical synthesis process may include mechanical milling or the like. The mechanical milling may include, for example, high-energy mechanical milling (HEMM). The HEMM refers to a process in which mechanical energy is applied to combine components.

The cathode-forming composition may contain a cathode active material, a binder, and a conductive material. The cathode-forming composition may contain a cathode active material and a binder. As the cathode active material and the binder, a cathode active material and a binder of an all-solid-state battery may be used. As the cathode-forming composition, a material known in the art may be used such that the cathode active material and the binder have a composition described above. The cathode-forming composition may further include a solvent. The binder may improve adhesion between components of cathode active material layers 121 and 122 and adhesion of the cathode active material layers 121 and 122 to a cathode current collector 123. A content of the binder may be in a range of about 1 part by weight to about 10 parts by weight or about 2 parts by weight to about 7 parts by weight with respect to 100 parts by weight of the cathode active material. The binder may be removed by being partially or entirely vaporized and/or carbonized during a sintering process of the cathode active material layers 121 and 122. The binder may be omitted.

A content of the conductive material may be in a range of about 1 part by weight to about 10 parts by weight or about 2 parts by weight to about 7 parts by weight with respect to 100 parts by weight of the cathode active material. The conductive material may be omitted.

In the anode-forming composition, as an anode active material and a binder, an anode active material and a binder of an all-solid-state battery may be used. As the anode-forming composition, a material known in the art may be used such that the anode active material and the binder have a composition described above. The conductive material and the binder may be selected to be the same as the conductive material and the binder used in the cathode active material layers 121 and 122, respectively. The binder may be removed by being partially or entirely vaporized and/or carbonized during a sintering process of anode active material layers 141 and 142. The binder and the conductive material may be omitted. The anode-forming composition may further include a solvent.

The cathode current collector composition and the anode current collector composition may each contain a metal selected from copper, aluminum, nickel, silver, gold, and an alloy thereof, a conductive oxide, or a combination thereof. As a specific example, aluminum may be used as a cathode current collector, and copper may be used as an anode current collector.

At least one of the first margin layer-forming composition, the second margin layer-forming composition, the third margin layer-forming composition, the first cover layer-forming composition, and the second cover layer-forming composition may include a material that allows the composition to have a pyrochlore crystalline material after heat-treating.

### Margin Layer/Cover Layer Forming Composition

A margin layer/cover layer-forming composition may include an element capable of forming a pyrochlore crystalline material and a content thereof. Specifically, the margin layer/cover layer-forming composition may include a pyrochlore crystalline material of Formula 1 or may include an element for forming the pyrochlore crystalline material of Formula 1 in an appropriate content (pyrochlore crystalline material precursor).

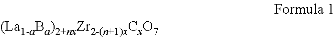

In Formula 1,
B may be one or more trivalent cations,
C may be one or more tetravalent cations, one or more pentavalent cations, or one or more hexavalent cations,

$$0 \leq a < 1 , and 0 \leq x < 0.66 , and$$

$$n = ( oxidation number of C ) - ( oxidation number of Zr ) .$$

In Formula 1, the oxidation number of Zr may be, for example, 4.

In Formula 1, B may be at least one of scandium (Sc), yttrium (Y), aluminum (Al), gallium (Ga), or indium (In), and C may be at least one of tungsten (W), niobium (Nb), bismuth (Bi), antimony (Sb), or tantalum (Ta).

In B and C of Formula 1, the trivalent to hexavalent cations may include, for example, at least one of Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Ag, Au, Cd, Al, Ga, In, Tl, Ge, Sn, Pb, Sb, Bi, Po, As, S, and Te.

In Formula 1, 0≤<1, 0≤a<0.8, 0≤a<0.5, or 0≤a<0.3.

In Formula 1, 0≤x<0.66, 0≤x<0.5, or 0≤x<0.4.

The pyrochlore crystalline material may be a lithium-free phase, for example, La₂₊ₓZr₂₋₂ₓTaₓO₇, wherein 0≤x<0.66.

The margin layer/cover layer-forming composition may be prepared by mixing a lithium precursor, a lanthanum precursor, a zirconium precursor, and a C element-containing precursor (for example, a tantalum precursor) in a ratio that allows formation of a pyrochlore crystalline material, and mechanochemically synthesizing the mixture.

The lanthanum precursor, the zirconium precursor, and the C element-containing precursor (for example, the tantalum precursor) may each include an oxide, a sulfate, a chloride, or a combination thereof, each containing lanthanum, zirconium, and a C element. The lanthanum precursor may include, for example, La₂O₃, LaCl₃, or the like, and the zirconium precursor may include, for example, ZrO₂, ZrCl₂, or the like. The tantalum precursor may include, for example, Ta₂O₅, TaCl₅, or the like.

The margin layer/cover layer-forming composition may further include an amorphous oxide.

The amorphous oxide may include Li, B, Si, and O, and may be, for example, glass including SiO₂, B₂O₃, and Li₂O. Here, the glass refers to a material that is crystallographically amorphous in X-ray diffraction or electron diffraction.

If the amorphous oxide includes Li₂O, a content of Li₂O may be in a range of about 20 mol % to about 75 mol %, about 25 mol % to about 75 mol %, about 30 mol % to about 75 mol %, about 40 mol % to about 75 mol %, or about 50 mol % to about 75 mol %. If the amorphous oxide includes SiO₂, a content of SiO₂ may be in a range of more than 0 mol % to about 70 mol %, about 5 mol % to about 50 mol %, or about 10 mol % to about 30 mol %. If the amorphous oxide includes B₂O₃, a content of B₂O₃ may be in a range of more than 0 mol % to about 80 mol %, about 5 mol % to about 80 mol %, about 10 mol % to about 60 mol %, or about 20 mol % to about 50 mol %. In addition, a content of each oxide in the amorphous oxide may be a content of each oxide with respect to the total content of respective oxides, and specifically, a ratio of the content (mol) of each oxide to the total amount (mol) of Li₂O and at least one of SiO₂, B₂O₃, and P₂O₅ may be a percentage (mol %).

Specifically, the margin layer/cover layer-forming composition may include a material for forming a pyrochlore crystal and a material for forming an amorphous phase. The margin layer/cover layer-forming composition may be in an amorphous phase. The margin layer/cover layer-forming composition may include a La precursor (for example, La₂O₃), a Li precursor (for example, Li₂O), a Zr precursor (for example, ZrO₂), a Ta precursor (Ta₂O₅), a Si precursor (SiO₂), and a B precursor (B₂O₃). The margin layer/cover layer-forming composition may be prepared by mixing a La precursor (for example, La₂O₃), a Li precursor (for example, Li₂O), a Zr precursor (ZrO₂), a Ta precursor (Ta₂O₅), a Si precursor (SiO₂), and a B precursor (B₂O₃) in a desired ratio, and mechanochemically synthesizing the mixture.

The margin layer/cover layer-forming composition may include lanthanum, zirconium, tantalum, lithium, boron, and silicon, wherein a content of lanthanum may be in a range of about 25 parts by weight to about 40 parts by weight, a content of lithium may be in a range of about 6 parts by weight to about 10 parts by weight, a content of zirconium may be in a range of about 8 parts by weight to about 15 parts by weight, a content of tantalum may be in a range of about 5 parts by weight to about 8 parts by weight, a content of boron may be in a range of about 4 parts by weight to about 6 parts by weight, and a content of silicon may be in a range of about 1 part by weight to about 3 parts by weight. A weight ratio of each component may be evaluated through ICP analysis.

In the margin layer/cover layer-forming composition, a weight ratio G_{La}/G_{Li} of lanthanum to lithium may be in a range of about 3 to about 5. For example, a content of lanthanum may be in a range of about 25 parts by weight to about 40 parts by weight, and a content of lithium may be in a range of about 6 parts by weight to about 10 parts by weight. Specifically, the weight ratio G_{La}/G_{Li} of lanthanum to lithium may be in a range of about 3.05 to about 4.99, about 3.1 to about 4.99, or about 3.14 to about 4.96. The content of lanthanum and lithium and the weight ratio of lanthanum to lithium may be evaluated through ICP analysis.

The weight ratio G_{La}/G_{Li} of lanthanum to lithium in the margin layer/cover layer-forming composition may be smaller than that of the solid electrolyte-forming composition.

The margin layer/cover layer-forming composition may further include a sintering aid like the solid electrolyte-forming composition.

Mechanochemical synthesis may include mechanical milling or the like. The mechanical milling may include, for example, HEMM. The HEMM refers to a process in which mechanical energy is applied to combine components.

An all-solid-state battery may be manufactured by heat-treating the stack obtained through such a process. The all-solid-state battery may have a structure of a first cover layer/cathode/solid electrolyte/anode/solid electrolyte/cathode/solid electrolyte/anode/second cover layer.

The heat-treating may be performed at a temperature of about 200° C. to about 700° C. For example, the heat-treating may be performed at a temperature of about 200° C. to about 600° C. or about 200° C. to about 550° C. The heat-treating may be performed at a pressure of about 5 MPa to about 300 MPa. The pressure may be in a range of, for example, about 5 MPa to about 250 MPa or about 10 MPa to about 250 MPa. When the heat-treating is performed under such conditions, an all-solid-state battery with improved energy density and rate characteristics may be manufactured.

The heat-treating may be simultaneously performed on the margin layer/cover layer-forming composition and the solid electrolyte precursor film (co-sintering). Therefore, the margin layer/cover layer-forming composition and the solid electrolyte precursor film may have similar behavior during a heat treating process. Specifically, an amorphous material in the margin layer/cover layer-forming composition may be partially or entirely crystallized into a pyrochlore crystal through the heat-treating, and an amorphous material in the solid electrolyte-forming composition may be partially or entirely crystallized from the amorphous material into a garnet cubic crystal through the heat-treating. Alternatively, a degree of crystallization of a pyrochlore crystalline material of the margin layer/cover layer-forming composition may be increased through the heat-treating, and a degree of crystallization of a garnet cubic crystalline material of the solid electrolyte-forming composition may be increased through the heat-treating.

Hereinafter, specific descriptions will be given with reference to examples and comparative examples, but one or more embodiments are not limited to the following examples.

### Reference Example 1: Preparation of Garnet-Type Solid Electrolyte

La₂O₃, ZrO₂, and Ta₂O₅ were mixed in a weight ratio of about 6:2:1, Li₂O was then added to the mixture. The combined mixture was added to a high energy ball mill to perform dry milling in an inert atmosphere. Li₂O was mixed in a content of 16 parts by weight with respect to 100 parts by weight of the total weight of La₂O₃, ZrO₂, and Ta₂O₅. (Garnet Li—La—Zr—Ta—O precursor)

A glass powder having a molar ratio of Li₂O, SiO₂, and B₂O₃ of 50:30:20 was mixed with the mixture, and dry milling was performed in an inert atmosphere to prepare an amorphous composition. A mixing volume ratio of the mixture to the glass powder in the amorphous composition was 95:5.

The amorphous composition was subjected to hot press sintering (hereinafter, HPS) at a temperature of 450° C. and a pressure of 250 MPa for 2 hours in an air atmosphere to prepare an oxide having a thickness of about 500 μm as a sintered body. ICP analysis was performed on the oxide. ICP analysis results are shown in Table 1 below.

### Example 1

La₂O₃, ZrO₂, and Ta₂O₅ were mixed in a weight ratio of about 6:2:1, and Li₂O was then added to the mixture. The combined mixture was added to a high energy ball mill to perform dry milling in an inert atmosphere. Li₂O was mixed in a content of 16 parts by weight with respect to 100 parts by weight of the total weight of La₂O₃, ZrO₂, and Ta₂O₅.

A glass powder (Li—B—Si—O glass powder) having a molar ratio of Li₂O, SiO₂, and B₂O₃ of 50:30:20 was mixed with the mixture and dry milled in an inert atmosphere to prepare an amorphous composition. A mixing volume ratio of the mixture to the glass powder was 50:50. Here, a mixing weight ratio of the mixture to the glass powder was 68:32.

The amorphous composition was subjected to HPS at a temperature of 450° C. and a pressure of 250 MPa for 2 hours in an air atmosphere to prepare an oxide having a thickness of about 500 μm as a sintered body. ICP analysis was performed on the oxide in the same manner as in Reference Example 1. ICP analysis results of the oxide are shown in Table 1 below.

### Example 2

An oxide was prepared in the same manner as in Example 1, except that a mixing volume ratio of the mixture of La₂O₃, ZrO₂, Ta₂O₅, and Li₂O to the glass powder was changed to 60:40. ICP analysis was performed on the oxide in the same manner as in Example 1. Here, a mixing weight ratio of the mixture to the glass powder was 76:24.

ICP analysis results are shown in Table 1 below.

### Example 3

An oxide was prepared in the same manner as in Example 1, except that a mixing volume ratio of the mixture of La₂O₃, ZrO₂, Ta₂O₅, and Li₂O to the glass powder was changed to 40:60. ICP analysis was performed on the oxide in the same manner as in Example 1. Here, a mixing weight ratio of the mixture to the glass powder was 59:41.

ICP analysis results are shown in Table 1 below.

### Comparative Example 1

A glass powder of Li₂O, SiO₂, and B₂O₃ with a molar ratio of 50:30:20 was subjected to HPS at a temperature of 450° C. and a pressure of 250 MPa for 1 hour in an air atmosphere to prepare an oxide having a thickness of about 500 μm.

### Comparative Example 2

A glass powder of Li₂O, SiO₂, and B₂O₃ with a molar ratio of 50:30:20 was subjected to HPS at a temperature of 450° C. and a pressure of 50 MPa for 1 hour in an air atmosphere to prepare an oxide having a thickness of about 500 μm.

### Evaluation Example 1: X-Ray Diffraction Analysis

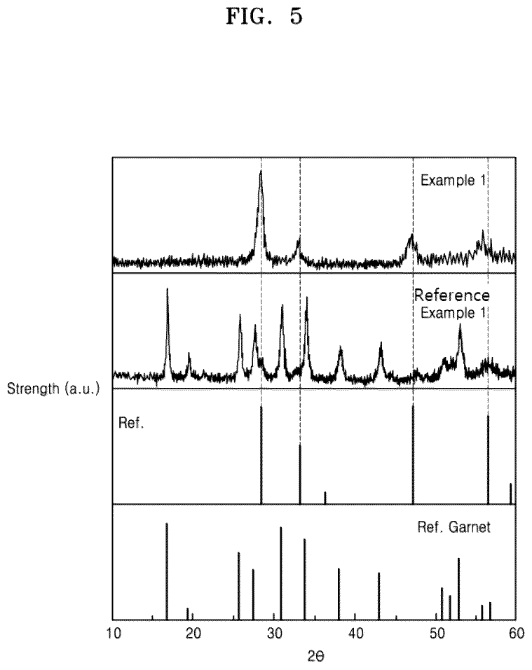

XRD spectra were measured on the oxides prepared in Example 1 and Reference Example 1, and the results are shown in FIG. 5. The XRD spectrum was measured through X'Pert Pro, PANalytical® using Cu Kα radiation (1.54056 Å). In FIG. 5, Ref. Garnet represents a cubic garnet phase, and Ref. represents a pyrochlore phase.

As shown in FIG. 5, the oxide of Reference Example 1 exhibited diffraction angle characteristics identical to those of a garnet type (Ref. Garnet) and exhibited diffraction angle characteristics different from those of the oxide of Example 1. It was confirmed that the oxide of Reference Example 1 included a cubic garnet crystalline material as a main phase. In addition, as seen from the ICP and XRD results, it may be seen that the compound further includes an amorphous material including Li, B, and Si.

As shown in FIG. 5, the oxide of Example 1 exhibited diffraction angle characteristics different from those of Reference Example 1. Since peaks appeared at diffraction angles 2θ of 28.349° (crystal plane (111)), 47.14° (crystal plane (220)), and 55.93° (crystal plane (311)), it was confirmed that the oxide of Example 1 included a pyrochlore-phase crystalline material as a main phase. In addition, as seen from the ICP and XRD results, it may be seen that the compound further includes an amorphous material including Li, B, and Si.

Thus, it may be confirmed that the oxide of Example 1 may be formed under the same temperature and pressure conditions as those under which a garnet-type solid electrolyte is formed.

### Evaluation Example 2: ICP Analysis

ICP analysis was performed on the oxides of the sintered bodies obtained according to Examples 1, 2, and 3, Reference Example 1, Comparative Example 1, and Comparative Example 2. ICP analysis results are listed in Table 1.

TABLE 1

| | Content (parts by weight) | | | | | | Weight ratio |
|---|---|---|---|---|---|---|---|
| Classification | La | Zr | Ta | Li | B | Si | La/Li |
| Reference | 44.6 | 14.6 | 9.7 | 5.5 | 0.7 | 0.3 | 8.05 |
| Example 1 | | | | | | | |
| Example 1 | 31.9 | 10.5 | 6.9 | 8.1 | 4.8 | 2.2 | 3.96 |
| Example 2 | 36.0 | 11.8 | 7.8 | 7.3 | 3.5 | 1.6 | 4.96 |
| Example 3 | 28.0 | 9.0 | 6.0 | 9.0 | 6.0 | 3.0 | 3.14 |
| Comparative | — | — | — | 14.4 | 15.0 | 7.0 | — |
| Example 1 | | | | | | | |
| Comparative | — | — | — | 14.4 | 15.0 | 7.0 | — |
| Example 2 | | | | | | | |

As indicated in Table 1, in the oxides of Examples 1, 2, and 3, La/Li weight ratios obtained through ICP analysis were 3.96, 4.96, and 3.14, respectively, which were in a range of 3 to 5. In contrast, the oxide of Reference Example 1 had a La/Li weight ratio of 8.05, which exceeded 5, and thus exhibited a composition distinct from that of the oxides of Examples 1 to 3.

### Evaluation Example 3: Measurement of Electronic Conductivity and Ionic Conductivity

Shielding electrodes were deposited by sputtering gold (Au) electrodes on opposite sides of each of oxide pellets prepared in Reference Example 1, Examples 1, 2, and 3, and Comparative Examples 1 and 2. By using a 2-probe method using an impedance analyzer (Solartron 1400A/1455A impedance analyzer), impedance was measured on a specimen having opposite sides on which the shielding electrodes are formed. A frequency was in a range of 1 Hz to 1 MHz, and an amplitude voltage was 10 mV. The measurement was performed at a temperature of 25° C. in a dry (less than 15% humidity) air atmosphere. A resistance value was obtained from an arc of a Nyquist plot for impedance measurement results, and an electrode area and a pellet thickness were corrected from the resistance value to calculate ionic conductivity and electronic conductivity. Results are shown in Table 2 below.

### Evaluation Example 4: Density (Relative Density)

The densities of the oxides prepared according to Reference Example 1, Examples 1, 2, and 3, and Comparative Examples 1 and 2 was investigated and are listed in Table 2. The density of a pellet was obtained as a ratio of a measured density to a theoretical density. Here, the measured density was determined by using a densimeter based on Archimedes' principle or from the apparent volume and weight of the pellet. The theoretical density of the pellet was determined in consideration of a theoretical density of 5.5 g/cm³ of garnet Li—La—Zr—Ta—O, a theoretical density of 2.4 g/cm³ of a Li—B—Si—O glass powder, and a mixing ratio thereof.

### Evaluation Example 5: Evaluation of Whether Pellet Shape is Maintained

Oxides were prepared according to Reference Example 1, Examples 1, 2, and 3, and Comparative Examples 1 and 2, and the oxides were formed into pellets. The pellet oxides were investigated to evaluate process compatibility. Whether the oxide maintains its pellet form is evaluated by checking the change in the weight of the sample injected before sintering if it does not maintain its cylindrical shape in appearance. In other words, it is evaluated by checking the degree to which it liquefies during pressurization and disappears outside the mold. If it is less than 20% of the weight of the sample injected before sintering, it is marked with x, and if it is 20% or more, it is marked with ∘. Evaluation results are shown in Table 2.

TABLE 2

| | Ionic | Electronic | Den- | Whether pellet |
|---|---|---|---|---|
| Classifi- | conductivity | conductivity | sity | shape is |
| cation | [S/cm] | [S/cm] | (%) | maintained |
| Reference | 1.22 × 10⁻⁵ | 1.94 × 10⁻¹⁰ | 85.6 | ◯ |
| Example 1 | | | | |
| Example 1 | 1.80 × 10⁻⁵ | 7.6 × 10⁻⁹ | 93.7 | ◯ |
| Example 2 | Less than 1.0 × 10⁻⁸ | 9.9 × 10⁻⁹ | 94.3 | ◯ |
| Example 3 | Less than 1.0 × 10⁻⁸ | 3.68 × 10⁻⁹ | 97.2 | ◯ |
| Comparative | N/A | N/A | N/A | X |
| Example 1 | | | | |
| Comparative | 1.0 × 10⁻⁷ | 1.3 × 10⁻¹¹ | 91.9 | ◯ |
| Example 2 | | | | |

As shown in Table 2, glass powders of Li₂O, SiO₂, and B₂O₃ alone could not form or maintain a shape under HPS conditions (450° C., 250 MPa, and 1 h) as indicated by Comparative Example 1. Comparative Example 2 could only form and maintain a shape under HPS conditions (450° C., 50 MPa, and 1 h). That is, the glass powders of Li₂O, SiO₂, and B₂O₃ cannot implement the desired ionic conductivity, electrical conductivity, density, shape, and the like in the same environment (450° C., 250 MPa, and 2 h) as conditions under which a garnet-type solid electrolyte of Reference Example 1 is formed. Therefore, the glass powders of Li₂O, SiO₂, and B₂O₃ may have poor process compatibility with a garnet-type solid electrolyte and may not be suitable as a margin layer/cover layer material.

As shown in Table 2, the oxides of Examples 1, 2, and 3 were able to implement and maintain a shape in the same environment (450° C., 250 MPa, and 1 h) as conditions under which the garnet-type solid electrolyte of Reference Example 1 was formed. Therefore, the oxides of Examples 1, 2, and 3 may have good process compatibility with a garnet-type solid electrolyte. In addition, the oxides of Examples 1, 2, and 3 have higher density than the garnet-type solid electrolyte of Reference Example 1. Therefore, the oxides of Examples 1, 2, and 3 are suitable for use as margin layer/cover layer materials of an all-solid-state battery using a garnet-type solid electrolyte.

Although embodiments have been described above, one or more embodiments are not limited thereto, and may be embodied by being modified in various ways within the scope of the claims, the detailed description, and the accompanying drawings. It is apparent that such modifications fall within the scope of the disclosure.

According to an aspect, an all-solid-state battery including a margin layer and/or a cover layer capable of effectively protecting internal cells from an external environment may be manufactured. The all-solid-state battery may have improved energy density and rate characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the FIG.s, it will be understood by those of ordinary skill in the art that various changes in form and details may be made therein without departing from the spirit and scope as defined by the following claims.

What is claimed is:

1. An all-solid-state battery comprising:
a multilayer structure;
a first cover layer stacked as a first outermost layer of the multilayer structure in a stacking direction; and
a second cover layer disposed opposite the first cover layer and stacked as a second outermost layer of the multilayer structure in the stacking direction,
wherein the multilayer structure comprises:
a solid electrolyte layer comprising a solid electrolyte;
a cathode layer provided on a first side of the solid electrolyte layer, wherein a portion of the cathode layer extends to a first edge of the solid electrolyte layer;
a first margin layer provided on an area of the first side of the solid electrolyte layer including an area proximate to a second edge of the solid electrolyte opposite the first edge in which the cathode layer is absent;
an anode layer provided on an opposite second side of the solid electrolyte layer, wherein a portion of the anode layer extends to the second edge of the solid electrolyte layer; and
a second margin layer provided on an area of the second side of the solid electrolyte layer including an area proximate to the first edge of the solid electrolyte in which the anode layer is absent,
wherein at least one of the first cover layer, the second cover layer, the first margin layer, or the second margin layer comprises an oxide comprising a pyrochlore crystalline material.

2. The all-solid-state battery of claim 1, wherein the pyrochlore crystalline material is a compound represented by Formula 1: 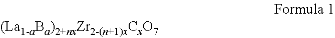
wherein, in Formula 1, B is one or more trivalent cations,
C is one or more tetravalent cations, one or more pentavalent cations, or one or more hexavalent cations,
$$0 \leq a < 1 , 0 \leq x < 0.66 , and$$
$$n = ( oxidation number of C ) - ( oxidation number of Zr ) .$$

3. The all-solid-state battery of claim 2, wherein, in Formula 1, B includes scandium (Sc), yttrium (Y), aluminum (Al), gallium (Ga), or indium (In), and
C includes tungsten (W), niobium (Nb), bismuth (Bi), antimony (Sb), or tantalum (Ta).

4. The all-solid-state battery of claim 1, wherein the pyrochlore crystalline material is a compound represented by Formula 2:

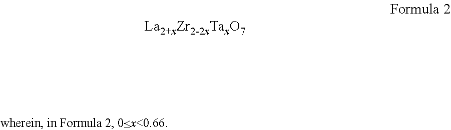

5. The all-solid-state battery of claim 1, wherein peaks in an X-ray diffraction (XRD) spectrum of the oxide appear at diffraction angles (2θ) of about 27.5° to about 29°, about 32° to about 33.5°, about 46.5° to about 48°, and about 55° to about 56.5°.

6. The all-solid-state battery of claim 1, wherein the oxide further comprises an amorphous material.

7. The all-solid-state battery of claim 1, wherein a content of the pyrochlore crystalline material in the oxide is in a range of about 50 parts by weight to about 99.9 parts by weight with respect to 100 parts by weight of a total weight of the oxide.

8. The all-solid-state battery of claim 1, wherein a weight ratio G_{La}/G_{Li} of lanthanum to lithium in at least one of the first cover layer, the second cover layer, the first margin layer, and the second margin layer is in a range of about 3 to about 5.

9. The all-solid-state battery of claim 1, wherein the oxide has lower ionic conductivity than the solid electrolyte.

10. The all-solid-state battery of claim 1, wherein the oxide has an ionic conductivity of 1.0×10⁻⁸ S/cm or less.

11. The all-solid-state battery of claim 1, wherein at least one of the first cover layer, the second cover layer, the first margin layer, and the second margin layer has an electrical conductivity of less than 1.0×10⁻⁷ S/cm.

12. The all-solid-state battery of claim 1, further comprising a third margin layer disposed on an extended plane of the solid electrolyte layer, wherein the third margin layer includes an area that is disposed between the first margin layer and the second margin layer.

13. The all-solid-state battery of claim 1, wherein a weight ratio G_{La}/G_{Li} of lanthanum to lithium of at least one of the first cover layer, the second cover layer, the first margin layer, and the second margin layer is smaller than that of the solid electrolyte layer.

14. A method of manufacturing an all-solid-state battery, the method comprising:
preparing a cathode structure having a first margin layer-forming composition that does not overlap a cathode layer;
preparing an anode structure formed having a second margin layer-forming composition that does not overlap an anode layer;
forming a multilayer structure having a solid electrolyte-forming composition disposed between the cathode structure and the anode structure;
providing a first cover layer-forming composition on a first outermost layer of the multilayer structure;
providing a second cover layer-forming composition on an second outermost layer of the multilayer structure, the second outermost layer disposed opposite the first outermost layer of the multilayer structure, to provide a stack; and
heat-treating the stack,
wherein the all-solid-state battery comprises:
the multilayer structure;
a first cover layer as the first outermost layer of the multilayer structure in a stacking direction; and
a second cover layer disposed opposite the first cover layer and as the second outermost layer in the stacking direction,
wherein the multilayer structure comprises:
a solid electrolyte layer comprising a solid electrolyte;
a cathode layer provided on a first side of the solid electrolyte layer, wherein a portion of the cathode layer extends to a first edge of the solid electrolyte layer;
a first margin layer provided on an area of the first side of the solid electrolyte layer including an area proximate to a second edge of the solid electrolyte opposite the first edge in which the cathode layer is absent;
an anode layer provided on an opposite second side of the solid electrolyte layer, wherein a portion of the anode layer extends to the second edge of the solid electrolyte layer; and
a second margin layer provided on an area of the second side of the solid electrolyte layer including an area proximate to the first edge of the solid electrolyte in which the anode layer is absent, and
wherein at least one of the first cover layer, the second cover layer, the first margin layer, or the second margin layer comprises an oxide comprising a pyrochlore crystalline material.

15. The method of claim 14, wherein the heat-treating of the stack is performed at a temperature of about 200° C. to about 700° C.

16. The method of claim 14, wherein the heat-treating of the stack is performed under a pressure condition of about 5 MPa to about 300 MPa.

17. The method of claim 14, wherein at least one of the first margin layer-forming composition, the second margin layer-forming composition, the first cover layer-forming composition, or the second cover layer-forming composition comprises a pyrochlore crystalline material, a pyrochlore crystalline material precursor, or a combination thereof.

18. The method of claim 17, wherein at least one of the first margin layer-forming composition, the second margin layer-forming composition, the first cover layer-forming composition, or the second cover layer-forming composition further comprises an amorphous material, an amorphous material precursor, or a combination thereof.

19. The method of claim 14, wherein the solid electrolyte-forming composition comprises a garnet-type solid electrolyte, a garnet-type solid electrolyte precursor, or a combination thereof.

20. The method of claim 14, wherein a weight ratio G_{La}/G_{Li} of lanthanum to lithium of at least one of the first margin layer-forming composition, the second margin layer-forming composition, the first cover layer-forming composition, or the second cover layer-forming composition is smaller than a weight ratio G_{La}/G_{Li} of lanthanum to lithium of the solid electrolyte-forming composition.
